(19) United States
(12) Patent Application Publication
(10) Pub. No.: US 2005/0061168 A1
(43) Pub. Date: Mar. 24, 2005

(54) Die press

(75) Inventors: Kevin L. Corcoran, Mission Viejo, CA (US); Trevor Freeman, Costa Mesa, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ellison Educational Equipment, Inc., Lake Forest, CA (US)

(21) Appl. No.: 10/911,387

(22) Filed: Aug. 4, 2004

Related U.S. Application Data
(60) Provisional application No. 60/492,622, filed on Aug. 4, 2003.

(51) Int. Cl. B30B 15/10

(52) U.S. Cl. 100/219; 83/625; 100/293

(57) ABSTRACT

Disclosed herein is a die press that includes a base and an opposing upper platen, one of the base or the upper platen being moveable relative to the other, the base having at least one lateral side, a retaining clip attached to the lateral side, wherein the first and second base extensions together with the base define a cavity, and wherein the grooves in the first and second base extensions are adapted for movement of a shuttle into and from the working area between the upper platen and the base.

### CROSS-REFERENCES TO RELATED APPLICATIONS

This application claims priority to U.S. Provisional Application No. 60/492,622 (Attorney Docket No. 021919-003900US) filed Aug. 4, 2003 and is herein incorporated by reference for all purposes.

### FIELD OF DISCLOSURE

The present disclosure relates to die presses and, more particularly, to a new platen die press and system.

### BACKGROUND OF THE DISCLOSURE

Dies and sheet cutting presses are used to cut various patterns out of sheet materials. The presses are designed to apply uniform pressure to a platen and to a die to cut through a sheet or a plurality of sheets simultaneously. Also, an amount of uniform pressure may be applied to the die to force a portion of the steel blade of the die or cutting edge of any die through only a portion of a sheet or combination of sheets. A cutting pad is used between a platen and the steel rule die, with the steel rule cutting into the cutting pad. Over time, the cutting pad wears and the die may wear, and the die press, as a result, may not cut evenly. Therefore, shims may be used to help to distribute the cutting forces from the platen to the cutting pad. In the past, loose shims may have been used in the die press. Loose shims, however, become displaced and result in uneven cuts and uneven pressure transfer from the die press to the die.

### BRIEF SUMMARY OF THE DISCLOSURE

Disclosed herein is a die press including a base and an opposing upper platen, one of the base or the upper platen being moveable relative to the other, the base having at least one lateral side, and a retaining clip is attached to the lateral side.

In another aspect of the disclosure, disclosed is a die press that is used to cut sheet material into shapes. The die press has a first rail extending from a base, and a second rail extending from the base. The rails are connected by a support. Each rail has a cut out to allow for a cutting pad to be slid along the rails. A die is typically located on top of the cutting pad, so the cutting pad and the die may be slid along the rails in the cut outs into a working area between the upper platen and a base, and wherein the die press further includes a first base extension extending from the base and a second base extension extending from the base, and wherein the first and second base extensions are generally parallel in relation to each other and wherein the base extensions have a top surface that are generally parallel with or at the same height as the base, and wherein the first and second base extensions together with the base define a cavity.

In yet another aspect of the disclosure, disclosed is a die press that includes a base and an opposing upper platen, one of the base or the upper platen being moveable relative to the other, the base having at least one lateral side, a retaining clip attached to the lateral side, and wherein the first and second base extensions together with the base define a cavity, and wherein the grooves in the first and second base extensions are adapted for movement of a shuttle into and from the working area between the upper platen and the base.

In another aspect of the present disclosure, a die press, as disclosed above, utilizes a retaining clip that is adapted to retain a shim. The shim has a thickness of approximately 0.002 inches to 0.125 inches, and more preferably the shim has a thickness of a range of approximately 0.002 inches to 0.010 inches. The shim may be made from a sheet of material made from paper, plastic, or metal. The shim, if made from a plastic material, may be made from one of a group of plastic materials including mylar, acetate, polycarbonate, polyvinyl chloride (PVC), polyethylene, or polypropylene. The shim also may be made from one of a group of metal materials including steel, stainless steel, brass, bronze, tin, or galvanized metal.

### BRIEF DESCRIPTION OF THE DRAWINGS

The disclosure will now be described in greater detail with reference to the preferred embodiments illustrated in the accompanying drawings, in which like elements bear like reference numerals, and wherein:

FIG. 1 is a front perspective view of the die press of the present disclosure;

FIG. 2 is a cross-sectional view taken from line 2-2 from FIG. 1;

FIG. 3 is a close-up view of FIG. 2;

FIG. 4 is an exploded view of the die press showing all of the components of the die press;

FIG. 5 is a cross sectional view taken from line 5-5 taken from FIG. 1 of the die press; and

FIGS. 6, 7, and 8 are views of a shim clip of the present disclosure.

### DETAILED DESCRIPTION OF THE DISCLOSURE

Disclosed herein is a die press used for cutting shapes out of sheet material. The die press is similar to the sheet cutting die press disclosed in U.S. Pat. No. 5,255,587, which is owned by the same Assignee of the present application, in which the issued patent is incorporated by reference in its entirety into this application as if set out in full herein.

Disclosed is a die press that is used to cut sheet material into shapes. The die press has a first rail extending from a base, and a second rail extending from the base with the rails being generally parallel in relation to each other. The rails are connected by a support. Each rail has a cut out or relief to allow for a cutting pad to be slid along the rails. A die is typically located on top of the cutting pad, so the cutting pad and the die may be slid along the rails in the cut outs into a working area between the upper platen and a base. A shim clip is secured onto the base to hold a shim that is located over the base if a shim is needed. The handle is oriented so that when the die press is in the closed or full cutting position, the handle is approximately horizontal with the ground.

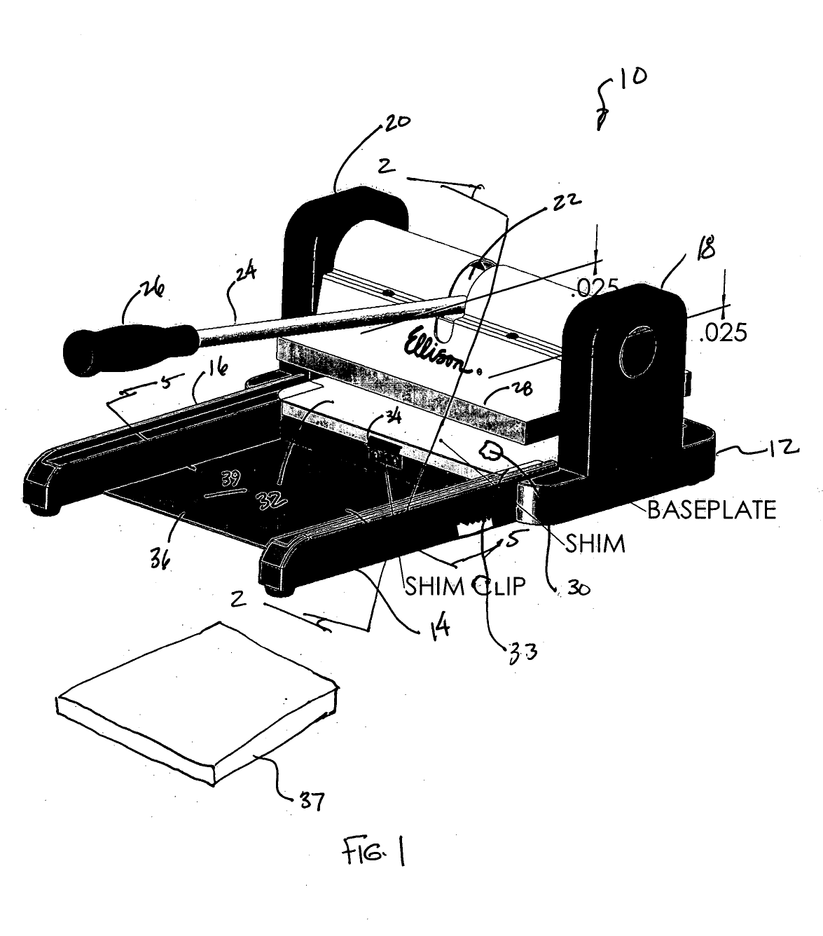

As shown in FIG. 1, the die press 10 has a base 12. A first rail 14 extends forward from the base 12, and an opposite second rail 16 also extends forward from the base 12. A first post 18 extends upward from the base 12, and an opposite second post 20 extends upward from the base 12. As shown in U.S. Pat. No. 5,255,587, cam 22 pivots about the first post 18 and the second post 20. Extending from the cam 22 is a handle 24. At the end of the handle is a cushioned grip 26. The first rail 14 and the second rail 16 that extend from the base 30 define a cavity 39 which allows the user's fingers to slide in and out of the cavity 39 area when the press is being utilized. A cutting pad 37, as will be further explained below, if slid along the rails into a working area defined by the area located between the upper platen 28 and the lower platen or base 30.

The die press 10 also has an upper platen 28 this is opposite of a lower platen 30, or a strengthened base area. Shown in FIG. 1 is a shim 32 that is used to adjust the cutting height of the assembly. The shim material may be made of any material, but has successfully been made of a mylar material that is approximately 0.005 inches to 0.010 inches thick.

In the alternative, the shim material has a thickness of approximately 0.002 inches to 0.125 inches thick. In yet another alternative, multiple shims are stacked together, wherein the shims are retained in place by the retaining clip 34 and the shims are stacked to a thickness of approximately 0.125 inches thick, depending upon the amount of adjustment that needs to be made by adding the shims to the working area between the upper platen 28 and the lower platen or base 30. In yet another embodiment, the shim has a thickness of approximately 0.002 inches to 0.010 inches.

The shim material may be made from a variety of sheet materials, such as paper, plastic, or metal, as long as the sheet material is thin enough to be pliable so as to bent, rolled, or angled around the lower platen or base 30 so as to be retained in place by being fastened to the base 30 by the retaining clip 34. In one alternative embodiment, the shim is made from one of a group of plastic materials, including mylar, acetate, polycarbonate, polyvinyl chloride (PVC), polyethylene, or polypropylene. In yet another alternative embodiment, the shim is made from one of a group of metal materials including steel, stainless steel, brass, bronze, tin, or galvanized metal. The shim, however, may be made of any material with a uniform thickness and has the amount of stiffness to withstand the forces of a platen press.

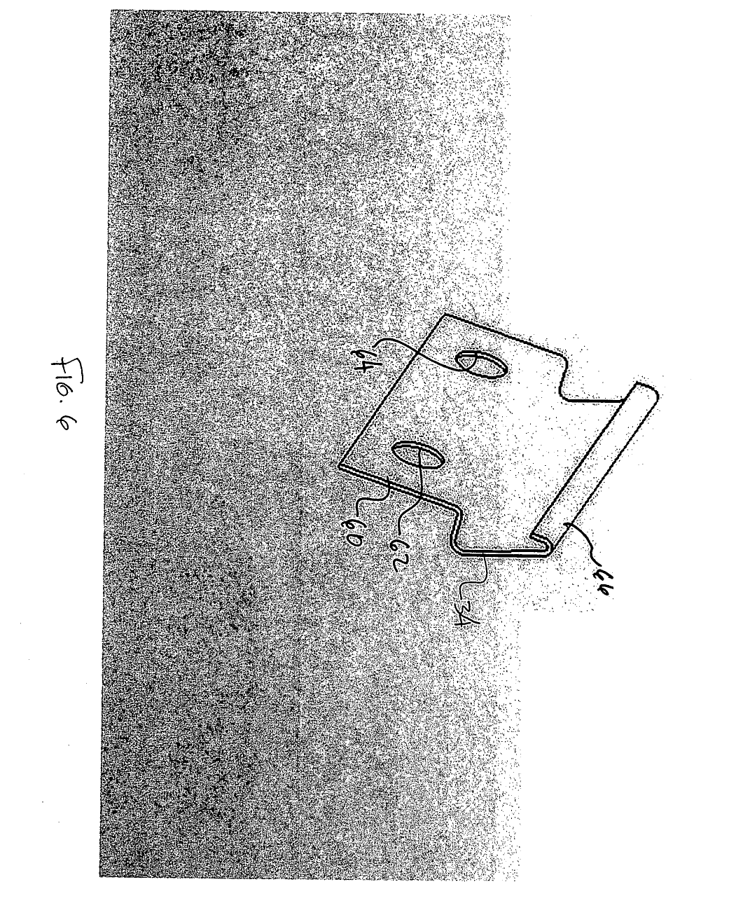

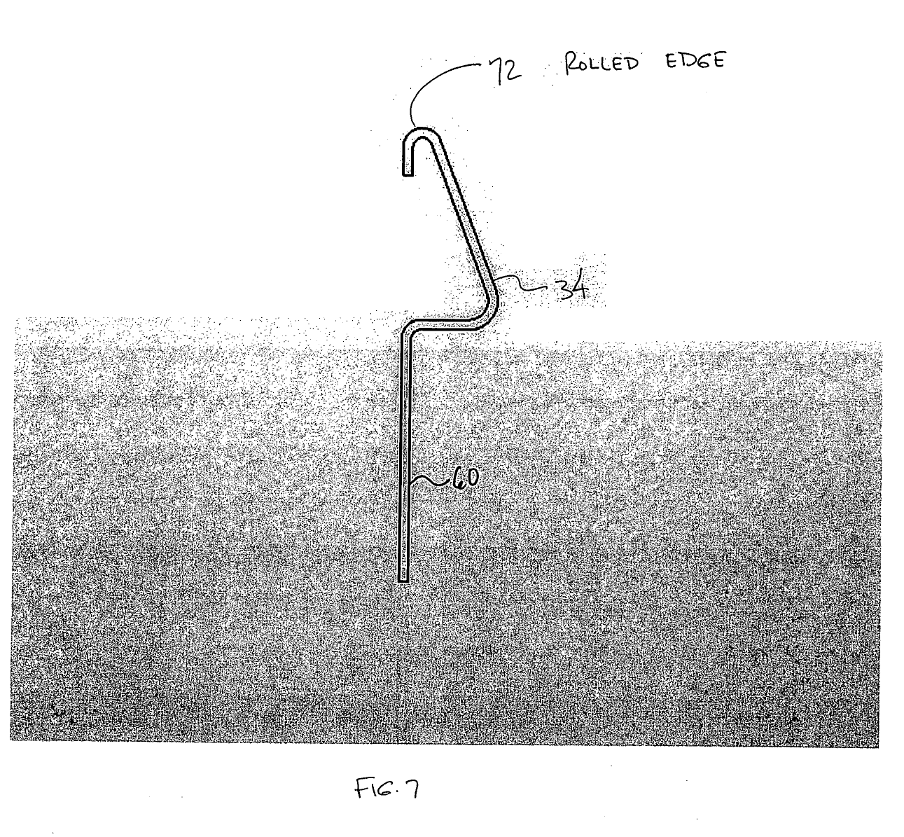

The shim 32 is held into place by a clip 34 that is fastened onto the base 12. As shown in FIGS. 6, 7, and 8, the clip is made of a spring material. The clip 34 has a rolled edge 72, as shown in FIG. 7, that allows the shim material to easily be slid into the clip 34. Also, the clip 34 is made of a resilient material, such as spring steel, so that multiple shims may be placed into the clip 34 as required by the cutting pad and/or the dies. The clip 34 is fastened onto the base with a pair of fasteners. The shim also is adjustable so that, as explained above, a plurality of shims may be utilized with the die press and retained by the retaining clip 34. In addition, the clip is adjustable by utilizing the fasteners so that the clip is adapted to be loosened and tightened to accommodate the placement and removal of one or a plurality of shims.

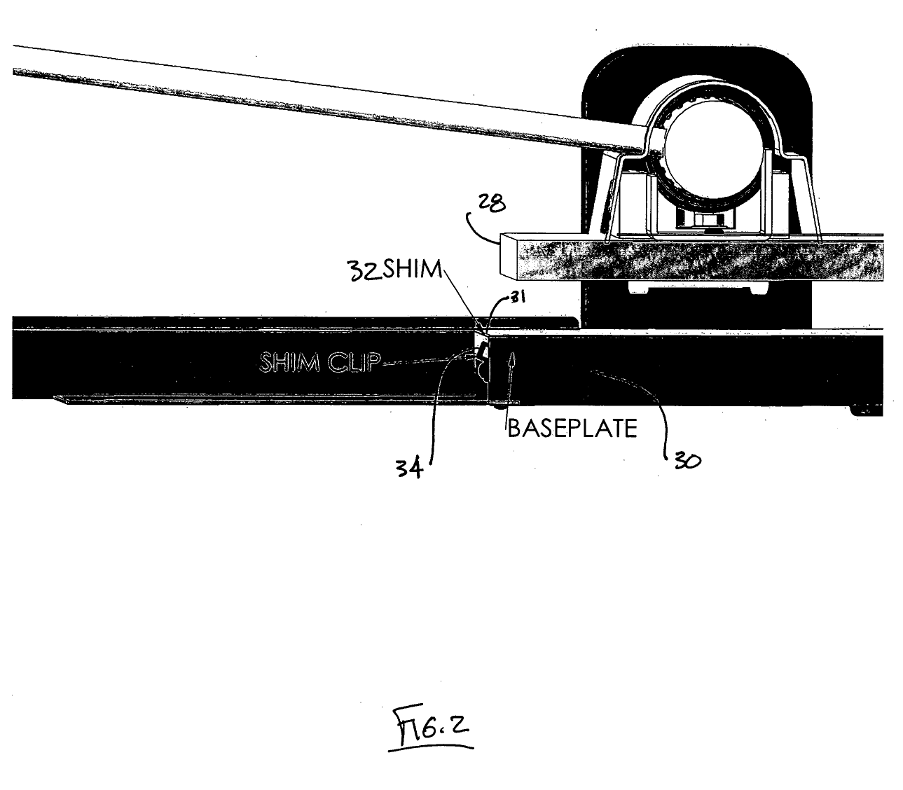

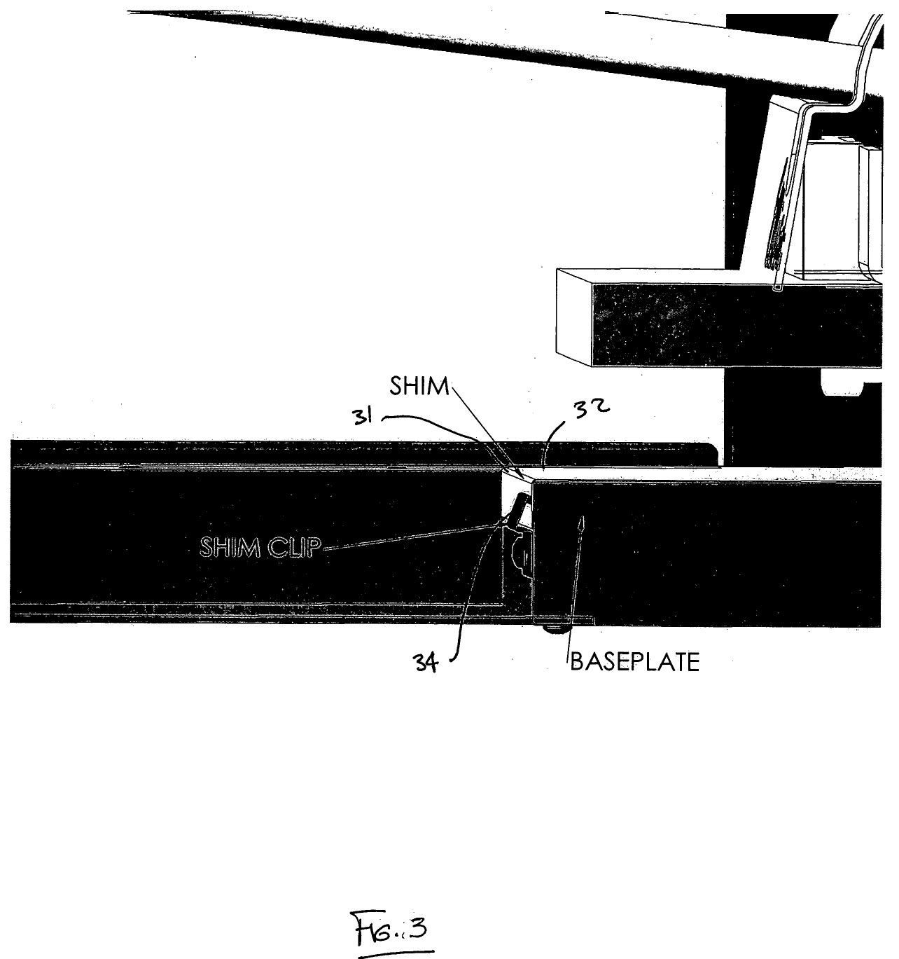

FIG. 3 illustrates a close-up view of a cross-sectional view of FIG. 2 further illustrating the shim 32, the shim rolled edge 31, and the shim clip 34.

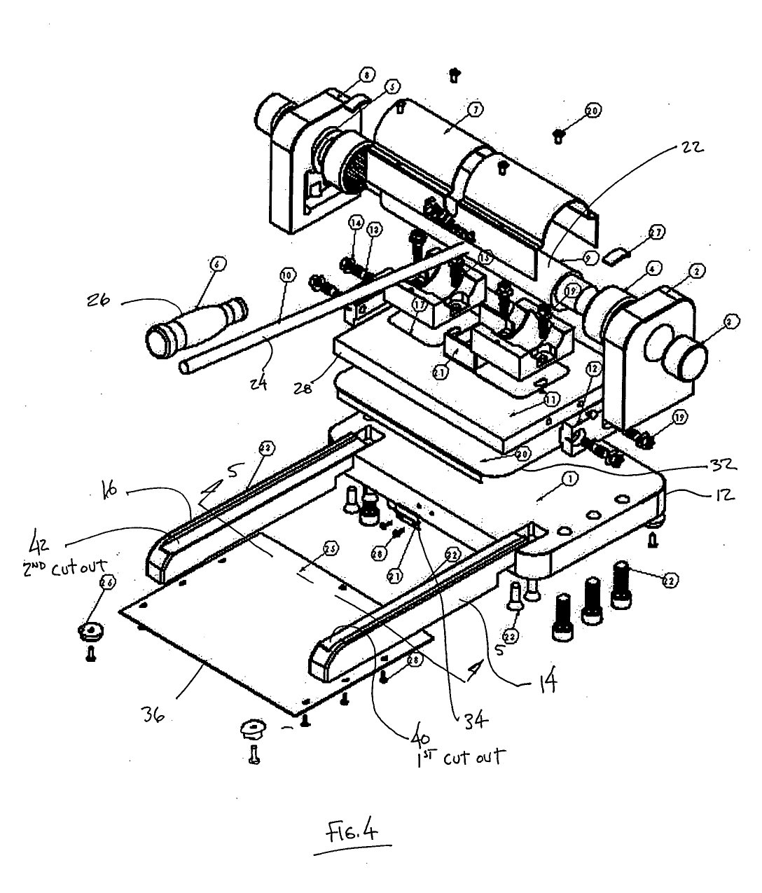

FIG. 4 is an exploded view of the die press of the present disclosure. FIG. 4 also illustrates that each rail has a cut out or relief. The first rail 14 has a first cut out 40, and the opposite second rail 16 has a second cut out 42.

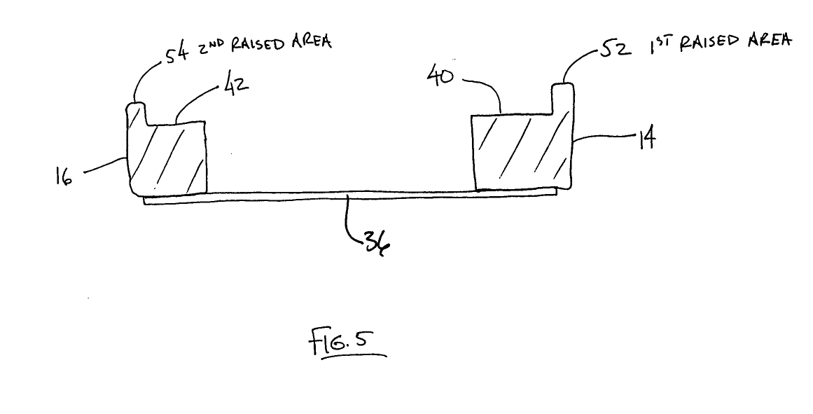

FIG. 5 illustrates the cut outs 40 and 42. Cut out 40 has a first raised area 52, and second cut out 42 has a second raised area 54. The cut outs and the raised areas allow a plastic cutting pad 37 and a die to be slid into the cut out areas and into the working area of the die press. The working area is located between the upper platen 28 and the base 12. As explained above, the shim 32 has radiused areas 33 that extend into the cut out areas 40 and 42 so that the shim extends the entire working area of the die press. The shim allows the user of the die press to make modifications to the cutting height of the die press as required, such as when the cutting pad or the die is worn, or when the cutting pad is replaced and a shim is necessary to make a proper cut.

The support 36 provides support to and stiffens the rails. The support also provides a surface that instructions may be placed on. The support is located back from the edge of the rails.

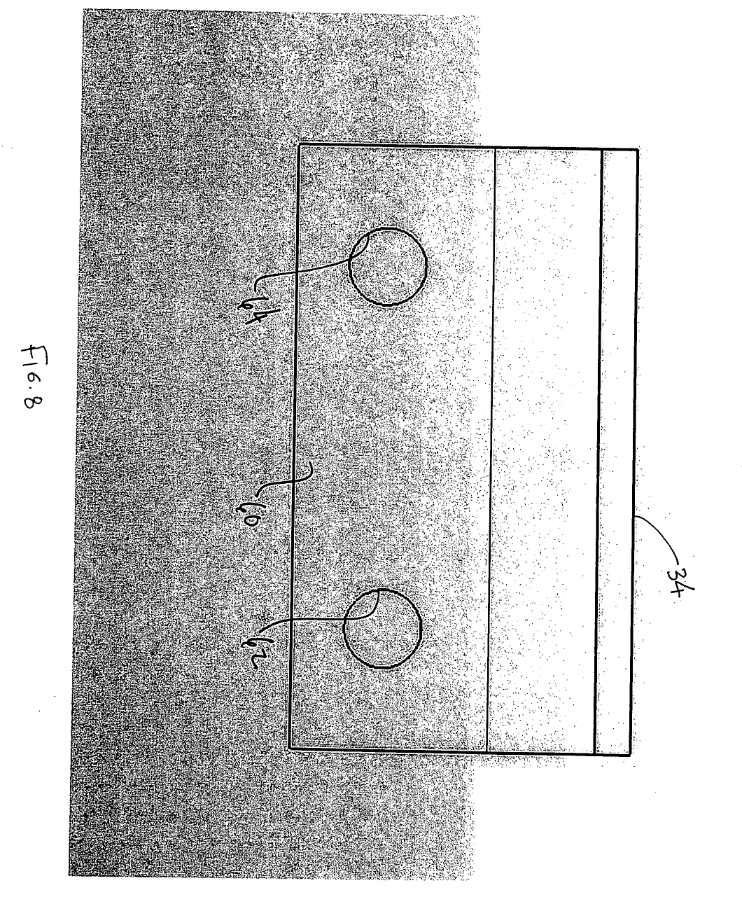

FIG. 6 illustrates a close-up view of the retaining clip 34, wherein the retaining clip includes a first flat portion 60 which is adapted to be located or fastened adjacent to a lateral side of the base, as shown in FIG. 1. The surface 60 includes a first aperture 62 and a second aperture 64 to allow for fasteners, such as quickset screws or the like to be located through aperture 62 and 64 and to be fastened to the lateral side of the base. The retaining clip 34 further includes a top rolled edge 72 with a top radius, as shown in FIG. 7, so as to allow the easy insertion of the shims between the retaining clip 34 and the base 30. FIG. 7 illustrates a side view of the retaining clip 34, and FIG. 8 illustrates a plan view of the retaining clip 34.

Although this disclosure has been shown and described with respect to detailed embodiments, those skilled in the art will understand that various changes in form and detail may be made without departing from the scope of the claimed disclosure.

1. A die press, comprising:
a base and an opposing upper platen, one of the base or the upper platen being moveable relative to the other;
the base having at least one lateral side; and
a retaining clip attached to the lateral side.

2. The die press of claim 1, wherein the die press further includes a first base extension extending from the base and a second base extension extending from the base, wherein the first and second base extensions are generally parallel in relation to each other and wherein the base extensions have a top surface that are generally parallel with or at the same height as the base.

3. The die press of claim 2, wherein the first and second base extensions together with the base define a cavity.

4. The die press of claim 3, wherein the first and second base extensions further comprise recesses adapted to allow a cutting pad to be slid laterally along the base extensions to and from the base.

5. The die press of claim 1, wherein the retaining clip is connected to the base and is adapted to be loosened and tightened relative to the base.

6. The die press of claim 5, wherein the retaining clip is adapted to retain a shim.

7. The die press of claim 6, wherein the shim has a thickness of approximately 0.002 inches to 0.125 inches.

8. The die press of claim 6, wherein the shim has a thickness of approximately 0.002 inches to 0.010 inches.

9. The die press of claim 6, wherein the shim is made from a sheeted material made from paper, plastic or metal.

10. The die press of claim 6, wherein the shim is made from one of a group of plastic materials including mylar, acetate, polycarbonate, polyvinyl chloride (PVC), polyethylene, or polypropylene.

11. The die press of claim 6, wherein the shim is made from one of a group of metal materials including steel, stainless steel, brass, bronze, tin, or galvanized metal.

12. The die press of claim 3, wherein the grooves in the first and second base extensions are adapted for movement of a shuttle into and from the working area between the upper platen and the base.

13. The die press of claim 12, wherein the retention clip is located generally lower than the grooves located in the first and second extensions.

14. The die press of claim 13, wherein the die press further includes a stop to stop the handle from being lowered when the die press is operated.

15. The die press of claim 6, wherein the die press further includes a cutting pad.

16. A die press having an upper platen and an opposing base, the upper platen being movable relative to the base, the die press further comprising:
a retaining clip; and
the base having at least one lateral side, with the retaining clip attached to the lateral side.

17. The die press of claim 16, wherein the die press further includes a first base extension extending from the base and a second base extension extending from the base, wherein the first and second base extensions are generally parallel in relation to each other and wherein the base extensions have a top surface that are generally parallel with or at the same height as the base.

18. The die press of claim 17, wherein the first and second base extensions together with the base define a cavity, and the first and second base extensions further comprise recesses adapted to allow a cutting pad to be slid laterally along the base extensions to and from the base.

19. The die press of claim 18, wherein the retaining clip is connected to the base and is adapted to be loosened and tightened relative to the base.

20. The die press of claim 19, wherein the retaining clip is adapted to retain a shim.

21. The die press of claim 20, wherein the shim has a thickness of approximately 0.002 inches to 0.125 inches.

22. The die press of claim 20, wherein the shim has a thickness of approximately 0.002 inches to 0.010 inches.

23. The die press of claim 20, The die press of claim 6, wherein the shim is made from a sheeted material made from paper, plastic or metal.

24. The die press of claim 20, wherein the shim is made from one of a group of plastic materials including mylar, acetate, polycarbonate, polyvinyl chloride (PVC), polyethylene, or polypropylene.

25. The die press of claim 20, wherein the shim is made from one of a group of metal materials including steel, stainless steel, brass, bronze, tin, or galvanized metal.

26. The die press of claim 20, wherein the grooves in the first and second base extensions are adapted for movement of a shuttle into and from the working area between the upper platen and the base.

27. The die press of claim 20, wherein the retention clip is located generally lower than the grooves located in the first and second extensions.

28. The die press of claim 20, wherein the die press further includes a stop to stop the handle from being lowered when the die press is operated.

29. The die press of claim 20, wherein the die press further includes a cutting pad.

30. A die press system, comprising:
a base and an opposing upper platen, one of the base or the upper platen being moveable relative to the other;
the base having at least one lateral side;
a retaining clip attached to the lateral side;
wherein the first and second base extensions together with the base define a cavity; and
wherein the grooves in the first and second base extensions are adapted for movement of a shuttle into and from a working area between the upper platen and the base.
